(19) United States
(12) Patent Application Publication
(10) Pub. No.: US 2025/0218192 A1
(43) Pub. Date: Jul. 3, 2025

(54) APPARATUS FOR RECOGNIZING OBJECT AND METHOD THEREOF

(71) Applicants: Hyundai Motor Company, Seoul (KR); Kia Corporation, Seoul (KR)

(72) Inventors: Mu Gwan Jeong, Hwaseong-si (KR); Nam Gyun Kim, Hwaseong-si (KR)

(21) Appl. No.: 18/828,334

(22) Filed: Sep. 9, 2024

(30) Foreign Application Priority Data
Jan. 3, 2024 (KR) 10-2024-0001034

(51) Int. Cl. G06V 20/58; B60W 30/09; B60W 60/00; G01S 17/931

(52) U.S. Cl. CPC G06V 20/58; B60W 30/09; B60W 60/0011; G01S 17/931; B60W 2552/20

(57) ABSTRACT

An object recognition apparatus includes a sensor (e.g., LIDAR) and a processor. The processor may obtain at least one point representing an external environment of a vehicle via the sensor, determine a plurality of path points representing positions on a ground. The plurality of path points may correspond to a path along which the vehicle is expected to travel. The processor may further classify each path point of the plurality of path points into at least one group of a plurality of groups, based on a distance between the vehicle and a position, on the ground, of each path point of the plurality of path points, determine a representative point for each group of the plurality of groups, determine a road profile comprising at least one of elevation information of the ground or contour information of the ground, and output a signal associated with autonomous driving control of the vehicle.

### CROSS-REFERENCE TO RELATED APPLICATION

This application claims the benefit of priority to Korean Patent Application No. 10-2024-0001034, filed in the Korean Intellectual Property Office on Jan. 3, 2024, the entire contents of which are incorporated herein by reference.

### TECHNICAL FIELD

The present disclosure relates to an object recognition apparatus and a method, and more particularly to a technology for identifying elevation information of the ground based on information obtained via light detection and ranging (LIDAR) equipment.

### BACKGROUND

In autonomous vehicles and vehicles equipped with a driving assistance device, a technology for detecting a surrounding environment is essential for avoiding obstacles and identifying hazards.

A vehicle may acquire information about its surroundings through one or more sensors, such as a LIDAR, a radar, and a camera.

If only a camera is relied on to acquire information about the vehicle's surroundings, the accuracy of elevation information of the surroundings may be lower than a reference value. In particular, the ride comfort and driving stability may be improved when the accuracy of elevation information of the ground on which the vehicle is traveling also improves. This is because vehicle control can be aided by the elevation information of the ground.

Accordingly, a technology for identifying elevation information of the ground through a LIDAR to improve the elevation information of the surroundings may be beneficial.

### SUMMARY

The present disclosure has been made to solve the above-mentioned problems occurring in at least some implementations while advantages achieved by those implementations are maintained intact.

An aspect of the present disclosure provides an object recognition apparatus and method for identifying elevation information of the ground for a path along which a host vehicle is expected to travel, via a LIDAR.

An aspect of the present disclosure provides an object recognition apparatus and method for improving accuracy of elevation information by identifying elevation information of the ground for a path along which a host vehicle is expected to travel, via a LIDAR.

An aspect of the present disclosure provides an object recognition apparatus and method for improving driving stability by improving accuracy of elevation information of the ground for a path along which a host vehicle is expected to travel if there is a road surface defect.

An aspect of the present disclosure provides an object recognition apparatus and method for improving driver's experience by improving the accuracy of elevation information of the ground for a path along which a host vehicle is expected to travel.

An aspect of the present disclosure provides an object recognition apparatus and method for obtaining elevation information of the ground for a path along which a host vehicle that is robust to noise is expected to travel.

An aspect of the present disclosure provides an object recognition apparatus and method for identifying a degree of confidence of points corresponding to the ground.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an apparatus may include: a sensor; and a processor. The processor may be configured to: obtain, via the sensor, at least one point representing an external environment of a vehicle; determine, among the at least one point, a plurality of path points representing positions on a ground. The plurality of path points may correspond to a path along which the vehicle is expected to travel. The processor may be further configured to: classify each path point of the plurality of path points into at least one group of a plurality of groups, based on a distance between the vehicle and a position, on the ground, of each path point of the plurality of path points; determine a representative point for each group of the plurality of groups, based on a position of each classified path point in a group, of the plurality of the groups, corresponding to the representative point; determine, based on an interpolation between representative points of two adjacent groups of the plurality of groups, a road profile including at least one of elevation information of the ground or contour information of the ground; and output, based on the determined road profile, a signal associated with autonomous driving control of the vehicle.

The processor may be configured to determine the plurality of path points by: determining a type of an object corresponding to each of the at least one point representing the external environment of the vehicle; and determining the plurality of path points based on the type of the object and a position of the object.

The at least one point may be included in input data of an artificial neural network (ANN). The processor may be configured to determine the type of the object by: determining the type of the object based on output data of the ANN.

The processor may be further configured to determine a degree of confidence of the representative point for each group of the plurality of groups, based on at least one of: a type of an object corresponding to classified path points included in a group corresponding to the representative point, a quantity of the classified path points included in the group corresponding to the representative point, or an elevation of the classified path points included in the group corresponding to the representative point.

A first representative point corresponding to a first group, having greater than a specified quantity of classified path points, may have a greater degree of confidence than a second representative point corresponding to a second group having less than the specified quantity of classified path points. A third representative point corresponding to a third group may have a greater degree of confidence than a fourth representative point corresponding to a fourth group. A maximum elevation value of classified path points in the third group not be greater than an average elevation value of the classified path points included in the third group by at least a specified amount. A maximum value of classified path points in the fourth group may be greater than an average elevation of the classified path points included in the fourth group by at least the specified amount.

The processor may be configured to classify each point of the plurality of path points by: classifying, into a first group, a first path point of the plurality of path points based on a first distance from a first position, on the ground, corresponding to the first path point to the vehicle satisfying a first distance range; and classifying, into a second group, a second path point of the plurality of path points based on a second distance from a second position, on the ground, corresponding to the second path point to the vehicle satisfying a second distance range that is different from the first distance range.

The processor may be further configured to: determine, based on a steering angle of the vehicle, an expected trajectory of two front wheels with respect to a travel direction; and determine the path based on the expected trajectory.

The processor may be configured to determine the representative point for each group of the plurality of groups by: determining the representative point based on at least one of: an average longitudinal position of one or more path points, of the plurality of path points, that are classified into a group corresponding to the representative point; and an average lateral position of the one or more path points that are classified into the group corresponding to the representative point, or an average elevation of the one or more path points that are classified into the group corresponding to the representative point.

The path may have a specified length.

The processor may be configured to determine the representative point for each group of the plurality of groups by determining the representative point based on a quantity of classified path points included in the group corresponding to the representative point being greater than a threshold quantity.

According to one or more example embodiments of the present disclosure, a method may include: obtaining, via a sensor, at least one point representing an external environment of a vehicle; determining, among the at least one point, a plurality of path points representing positions on a ground. The plurality of path points may correspond to a path along which the vehicle is expected to travel. The method may further include: classifying each path point of the plurality of path points into at least one group of a plurality of groups, based on a distance between the vehicle and a position, on the ground, of each path point of the plurality of path points; determining a representative point for each group of the plurality of groups, based on a position of each classified path point in a group, of the plurality of the groups, corresponding to the representative point; determining, based on an interpolation between representative points of two adjacent groups of the plurality of groups, a road profile including at least one of elevation information of the ground or contour information of the ground; and outputting, based on the determined road profile, a signal associated with autonomous driving control of the vehicle.

Determining the plurality of path points may include: determining a type of an object corresponding to each of the at least one point representing the external environment of the vehicle; and determining the plurality of path points based on the type of the object and a position of the object.

The at least one point may be included in input data of an artificial neural network (ANN). Determining the type of the object may include: determining the type of the object based on output data of the ANN.

The method may include: determining a degree of confidence of the representative point for each group of the plurality of groups, based on at least one of: a type of an object corresponding to classified path points included in a group corresponding to the representative point, a quantity of the classified path points included in the group corresponding to the representative point, or an elevation of the classified path points included in the group corresponding to the representative point.

A first representative point corresponding to a first group, having greater than a specified quantity of classified path points, may have a greater degree of confidence than a second representative point corresponding to a second group having less than the specified quantity of classified path points. A third representative point corresponding to a third group may have a greater degree of confidence than a fourth representative point corresponding to a fourth group. A maximum elevation value of classified path points in the third group may not be greater than an average elevation value of the classified path points included in the third group by at least a specified amount. A maximum value of classified path points in the fourth group may be greater than an average elevation of the classified path points included in the fourth group by at least the specified amount.

The classifying of each point of the plurality of path points may include: classifying, into a first group, a first path point of the plurality of path points based on a first distance from a first position, on the ground, corresponding to the first path point to the vehicle satisfying a first distance range; and classifying, into a second group, a second path point of the plurality of path points based on a second distance from a second position, on the ground, corresponding to the second path point to the vehicle satisfying a second distance range that is different from the first distance range.

The method may further include: determining, based on a steering angle of the vehicle, an expected trajectory of two front wheels with respect to a travel direction; and determining the path based on the expected trajectory.

Determining the representative point for each group of the plurality of groups may include: determining the representative point based on at least one of: an average longitudinal position of one or more path points, of the plurality of path points, that are classified into a group corresponding to the representative point; and an average lateral position of the one or more path points that are classified into the group corresponding to the representative point, or an average elevation of the one or more path points that are classified into the group corresponding to the representative point.

The path may have a specified length.

Determining the representative point for each group of the plurality of groups may include: determining the representative point based on a quantity of classified path points included in the group corresponding to the representative point being greater than a threshold quantity.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a configuration of an object recognition apparatus according to an embodiment of the present disclosure;

FIG. 2 shows an example of obtaining a road profile through a sensor (e.g., LIDAR) in an object recognition apparatus or an object recognition method according to an embodiment of the present disclosure;

FIG. 3 illustrates a flowchart of operations of an object recognition apparatus for identifying a degree of confidence and obtaining a road profile in the object recognition apparatus or an object recognition method according to an embodiment of the present disclosure;

FIG. 4 illustrates another flowchart of operation of an object recognition apparatus for identifying a degree of confidence and obtaining a road profile in an object recognition apparatus or an object recognition method according to an embodiment of the present disclosure;

FIG. 5 shows an example of a path along which a host vehicle is expected to travel in an object recognition apparatus or an object recognition method according to an embodiment of the present disclosure;

FIG. 6 shows an example of a representative point identified from classified points in an object recognition apparatus or an object recognition method according to an embodiment of the present disclosure;

FIG. 7 illustrates a flowchart of operation of an object recognition apparatus for obtaining a road profile in an object recognition apparatus or an object recognition method according to an embodiment of the present disclosure;

FIG. 8 illustrates a flowchart of operation of an object recognition apparatus for assigning a degree of confidence to a representative point in an object recognition apparatus or an object recognition method according to an embodiment of the present disclosure;

FIG. 9 illustrates graphs for deriving criteria for assigning a degree of confidence in an object recognition apparatus or an object recognition method, according to an embodiment of the present disclosure;

FIG. 10 illustrates an example of a road profile according to an embodiment of the present disclosure; and

FIG. 11 illustrates a computing system related to an object recognition apparatus or an object recognition method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

In addition, in the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

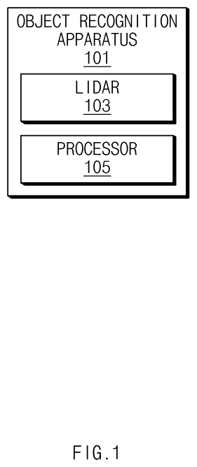

Hereinafter, embodiments of the present disclosure will be described in detail with reference to FIGS. 1 to 11.

FIG. 1 is a block diagram showing a configuration of an object recognition apparatus according to an embodiment of the present disclosure.

Referring to FIG. 1, an object recognition apparatus 101 may include a sensor (e.g., LIDAR) 103 and a processor 105.

The sensor (e.g., LIDAR) 103 and the processor 105 may be electronically and/or operably coupled with each other by an electronic component such as a communication bus.

According to an embodiment, hereinafter, combining pieces of hardware operatively may mean a direct connection or an indirect connection between the pieces hardware being established in a wired or wireless manner such that first hardware of the pieces of hardware is controlled by second hardware of the pieces of hardware. The type and/or number (e.g., quantity) of hardware included in the object recognition apparatus 101 is not limited to that shown in FIG. 1. For example, the object recognition apparatus 101 may include only some of hardware components shown in FIG. 1.

According to an embodiment, the processor 105 of the object recognition apparatus 101 may identify an external environment of a host vehicle based on the sensor (e.g., LIDAR) 103. For example, the processor 105 of the object recognition apparatus 101 may acquire at least one point representing the external environment (e.g., ground, road, sidewalk, parking lot) through the sensor (e.g., LIDAR) 103.

According to an embodiment, the processor 105 of the object recognition apparatus 101 may identify the type of an object corresponding to each of points included in at least one point representing the external environment of the host vehicle. For example, an object may constitute an external environment. For example, types of objects may include ground, sidewalk, road, and parking lot.

According to an embodiment, the processor 105 of the object recognition apparatus 101 may determine the type of an object corresponding to each of points included in the output data of an artificial neural network (ANN) based on each of points included in at least one point representing the external environment of the host vehicle included in the input data of the artificial neural network.

According to an embodiment, the processor 105 of the object recognition apparatus 101 may identify a path (e.g., an expected trajectory) along which the two preceding wheels (e.g., two front wheels of a vehicle moving forward or two rear wheels of a vehicle moving backward) are expected to travel (e.g., move) with respect to the direction of travel (e.g., a direction of movement) based on the steering angle of the host vehicle, and identify a path along which the host vehicle is expected to travel based on the path along which the two wheels are expected to travel.

According to an embodiment, the processor 105 of the object recognition apparatus 101 may identify a path point that is a point included in the path along which the host vehicle is expected to travel and representing the ground (e.g., terrain), among the at least one point, based on the type of an object and the position of the object. For example, the ground (e.g., the ground) may include surfaces on which the host vehicle is able to drive, such as sidewalks, roads, and parking lots.

According to an embodiment, the processor 105 of the object recognition apparatus 101 may classify the path point into at least one group according to the distance between the host vehicle and the ground corresponding to the path point.

According to an embodiment, the processor 105 of the object recognition apparatus 101 may classify, into a first group, a first path point if the distance between the host vehicle and the ground corresponding to the first path point included in the path point satisfies a first distance range.

According to an embodiment, the distance between the host vehicle and the ground corresponding to the first path point may include a distance from the ground corresponding to the first path point to the center of the bumper of the host vehicle, but the embodiment of the present disclosure is not limited thereto. According to another embodiment, a point on the host vehicle that serves as a reference for a distance from the first path point to the host vehicle may include a point other than the center of the bumper.

According to an embodiment, the processor 105 of the object recognition apparatus 101 may classify a second path point into a second group rather than the first group based on the fact that the distance between the host vehicle and the ground corresponding to the second path point included in the path point does not satisfy the first distance range, and satisfies a second distance range that is different from the first distance range.

According to an embodiment, the distance between the host vehicle and the ground corresponding to the second path point may include a distance from the ground corresponding to the second path point to the center of the bumper of the host vehicle, but the embodiment of the present disclosure is not limited thereto. According to another embodiment, a point on the host vehicle that serves as a reference for a distance from the second path point to the host vehicle may include a point other than the center of the bumper.

According to an embodiment, the processor 105 of the object recognition apparatus 101 may identify one representative point for each group based on the position of a classified point, which is a path point classified into each of groups included in at least one group.

For example, the longitudinal position of a representative point corresponding to a specific group may include the average value of the longitudinal positions of classified points included in the specific group. For example, the lateral position of a representative point corresponding to a specific group may include the average value of the lateral positions of classified points included in the specific group. For example, the elevation of a representative point corresponding to a specific group may include the average value of the elevations of classified points included in the specific group.

According to an embodiment, if the number (e.g., quantity) of classified points included in a specific group is greater than a threshold number, the processor 105 of the object recognition apparatus 101 may identify a representative point corresponding to the specific group according to the positions of the classified points included in the specific group.

If the number of classified points included in a specific group is not greater than the threshold number, the processor 105 of the object recognition apparatus 101 may not identify a representative point corresponding to the specific group. This is because the points are determined as being unreliable if the number of points is equal to or less than the threshold number.

According to an embodiment, the processor 105 of the object recognition apparatus 101 may obtain a road profile representing at least one of ground elevation information for a path along which the host vehicle is expected to travel or contour (e.g., shape) information of the ground for the path along which the host vehicle is expected to travel, or any combination thereof, based on performing an interpolation between representative points corresponding to two adjacent groups separated by a distance from the ground corresponding to the representative point to the host vehicle. For example, the road profile may represent elevation information of the path along which the host vehicle is expected to travel.

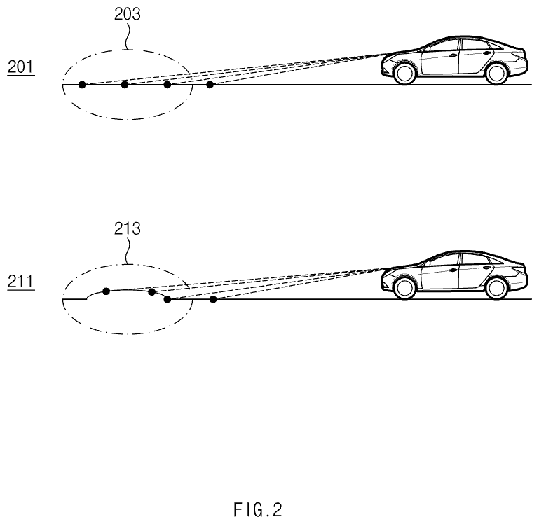

FIG. 2 shows an example of obtaining a road profile through a sensor (e.g., LIDAR) in an object recognition apparatus or an object recognition method according to an embodiment of the present disclosure.

Referring to FIG. 2, in a first situation 201, the ground elevation of a first portion 203 on a path along which a host vehicle is expected to travel may be less than or equal to a specified elevation.

In a second situation 211, the ground elevation of a second portion 213 of the path along which the host vehicle is expected to travel may be greater than a specified elevation.

According to an embodiment, in the first situation 201, the first portion 203 may represent a flat ground that does not include a speed bump, although a road surface marking indicating a speed bump is displayed.

The speed bump is a structure installed to prevent vehicle speeding and improve traffic safety on roads or parking lots, and may be installed in a protruding form on the road surface. The road surface marking indicating the speed bump may be painted on the speed bump. The road surface marking indicating the speed bump may mainly be expressed as white and yellow lines.

In the first situation 201, because the speed bump marking and the actual structure of the ground do not match each other, it may be difficult for the processor of an existing object recognition apparatus to figure out the structure of the ground for the first portion 203 through a camera. Because the processor of the object recognition apparatus according to an embodiment determines the structure of the ground through a sensor (e.g., LIDAR), the processor of the object recognition apparatus may identify that a speed bump is not included in the first portion 203. The processor of the object recognition apparatus according to an embodiment may identify that the elevation of the first portion 203 is identical to the elevation of the road on which the host vehicle is traveling.

According to an embodiment, in the second situation 211, the second portion 213 may not include a road surface marking indicating a speed bump, but the ground including the speed bump may appear. In other words, the second portion 213 may include a speed bump whose paint has been lost.

In the second situation 211, because the marking of the ground and the actual structure of the ground do not match each other, it may be difficult for the processor of an existing object recognition apparatus to figure out the speed bump included in the second portion 213 through a camera. Because the processor of the object recognition apparatus according to an embodiment determines the structure of the ground through a sensor (e.g., LIDAR), the processor of the object recognition apparatus may identify that a speed bump is included in the second portion 213. The processor of the object recognition apparatus according to an embodiment may identify that the elevation of the second portion 213 is higher than the elevation of the road on which the host vehicle is traveling.

The processor of the object recognition apparatus according to an embodiment may improve driving stability by improving the accuracy of road profiles according to ground structures different from painted markings, or road surface defects. Road surface defects may include raised obstacles, such as speed bumps, or dug-in obstacles, such as potholes.

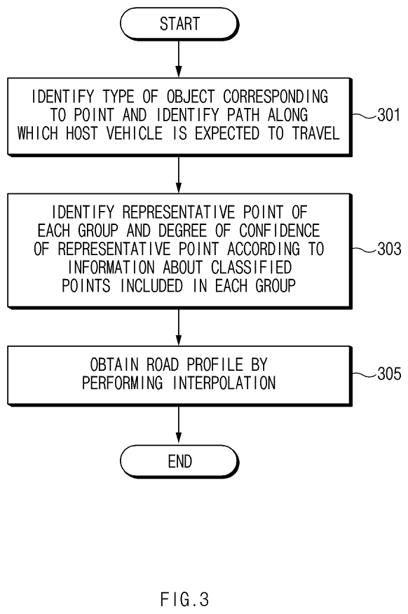

FIG. 3 illustrates a flowchart of operations of an object recognition apparatus for identifying a degree of confidence and obtaining a road profile in the object recognition apparatus or an object recognition method according to an embodiment of the present disclosure.

Hereinafter, it is assumed that the processor 105 of the object recognition apparatus 101 of FIG. 1 performs the process of FIG. 3. Also, in the description of FIG. 3, the operations described as being performed by the processor of the object recognition apparatus may be understood as being controlled by the processor 105 of the object recognition apparatus 101.

Referring to FIG. 3, in a first operation 301, the processor of an object recognition apparatus according to an embodiment may identify the type of an object corresponding to a point and identify a path along which a host vehicle is expected to travel.

According to an embodiment, the type of an object corresponding to a point may include the ground, sidewalks, roads, and parking lots.

According to an embodiment, the processor of the object recognition apparatus may identify a path (e.g., an expected trajectory) along which the two preceding wheels (e.g., two front wheels of a vehicle moving forward or two rear wheels of a vehicle moving backward) are expected to travel (e.g., move) with respect to the direction of travel (e.g., a direction of movement), based on the steering angle of the host vehicle. The processor of the object recognition apparatus may identify the path along which the host vehicle is expected to travel, based on the path the two wheels are expected to travel.

According to an embodiment, the processor of the object recognition apparatus may identify a path point, which is a point that represents the ground and is included in a path along which the host vehicle is expected to travel, among points.

In a second operation 303, the processor of the object recognition apparatus according to an embodiment may identify a representative point of each group and a degree of confidence of the representative point according to information about classified points included in each group.

According to an embodiment, the processor of the object recognition apparatus may classify path points into at least one group according to the distance from the ground corresponding to the path point to the host vehicle to identify the representative point and the degree of confidence of the representative point.

According to one embodiment, the processor of the object recognition apparatus may identify one representative point for each group based on the position of a classified point, which is a path point classified into each of groups included in at least one group.

For example, the processor of the object recognition apparatus may classify a classified point into at least one group according to a distance from the ground corresponding to the classified point to the host vehicle.

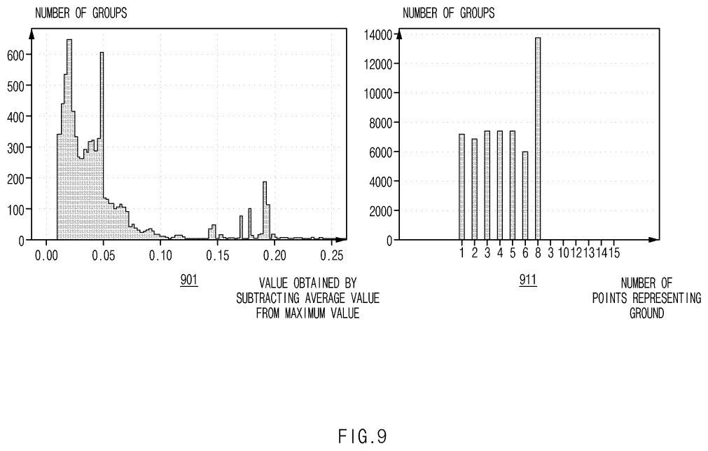

According to an embodiment, the processor of the object recognition apparatus may identify a degree of confidence of the representative point corresponding to each group based on at least one of the type of an object corresponding to classified points included in each group, the number of the classified points included in each group, or the elevation of the classified points included in each group, or any combination thereof. A method for identifying a degree of confidence will be described below with reference to FIG. 9.

In a third operation 305, the processor of the object recognition apparatus according to an embodiment may obtain a road profile by performing interpolation.

According to one embodiment, the processor of the object recognition apparatus may obtain a road profile indicative of at least one of ground elevation information for a path along which the host vehicle is expected to travel, or contour (e.g., shape) information of the ground for the path along which the host vehicle is expected to travel, or any combination thereof, based on performing interpolation between representative points corresponding to two adjacent groups separated by a distance from the ground corresponding to the representative points to the host vehicle.

The interpolation may refer to identifying a function value for a third variable located between a first variable value and a second variable value, based on a function value for the first variable value and a function value for the second variable value.

According to an embodiment, the processor of the object recognition apparatus may estimate the elevation of the ground between the position of the ground corresponding to a first representative point and the position of the ground corresponding to a second representative point through interpolation.

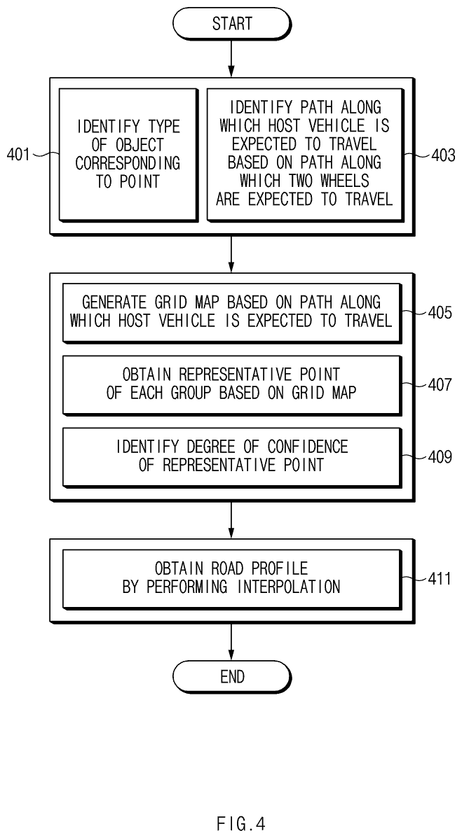

FIG. 4 illustrates another flowchart of operation of an object recognition apparatus for identifying a degree of confidence and obtaining a road profile in an object recognition apparatus or an object recognition method according to an embodiment of the present disclosure.

Hereinafter, it is assumed that the processor 105 of the object recognition apparatus 101 of FIG. 1 performs the process of FIG. 4. Also, in the description of FIG. 4, the operations described as being performed by the processor of the object recognition apparatus may be understood as being controlled by the processor 105 of the object recognition apparatus 101.

Referring to FIG. 4, in a first operation 401, the processor of the object recognition apparatus according to an embodiment may identify the type of an object corresponding to a point.

In a second operation 403, the processor of the object recognition apparatus according to an embodiment may identify a path along which a host vehicle is expected to travel based on a path along which two wheels are expected to travel. According to an embodiment, the first operation 401 may be performed before the second operation 403 or may be performed after the second operation 403 has been performed.

In a third operation 405, the processor of the object recognition apparatus according to an embodiment may generate a grid map based on a path along which the host vehicle is expected to travel. According to an embodiment, the grid map may include a plurality of grids separated according to the distance from the ground corresponding to a point to the host vehicle. Each grid included in the plurality of grids may correspond to each group.

In a fourth operation 407, the processor of the object recognition apparatus according to an embodiment may obtain a representative point for each group based on the grid map.

In a fifth operation 409, the processor of the object recognition apparatus according to an embodiment may identify the degree of confidence of the representative point.

In a sixth operation 411, the processor of the object recognition apparatus according to an embodiment may obtain a road profile by performing interpolation.

According to an embodiment, the road profile may represent at least one of ground elevation information for a path along which the host vehicle is expected to travel, or ground contour (e.g., shape) information for the path along which the host vehicle is expected to travel, or any combination thereof.

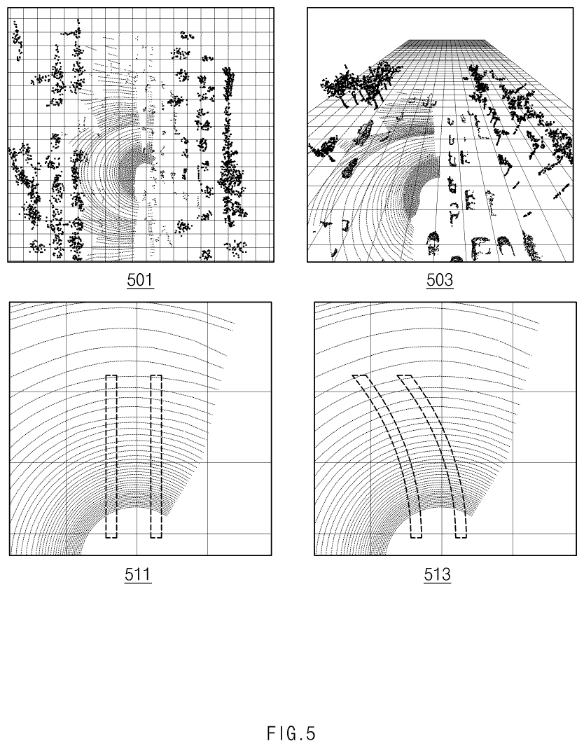

FIG. 5 shows an example of a path along which a host vehicle is expected to travel in an object recognition apparatus or an object recognition method according to an embodiment of the present disclosure.

Referring to FIG. 5, a first screen 501 may include points representing an external environment. A second screen 503 may include points representing an external environment that is different from the external environment included in the first screen 501. The external environment may include roads, vehicles, and trees. Points representing a road may be included in points representing the ground.

A first sensor (e.g., LIDAR) screen 511 may include points representing the ground and a path along which a host vehicle on a straight path is expected to travel. A second sensor (e.g., LIDAR) screen 513 may include points representing the ground and a path along which a vehicle on a curved path is expected to travel.

According to an embodiment, on the first sensor (e.g., LIDAR) screen 511, a path identified based on the steering angle of the host vehicle if the steering wheel of the host vehicle is not operated may be displayed.

According to an embodiment, on the second sensor (e.g., LIDAR) screen 513, a path identified based on the steering angle of the host vehicle if the steering wheel of the host vehicle is operated to the left with respect to the host vehicle may be displayed.

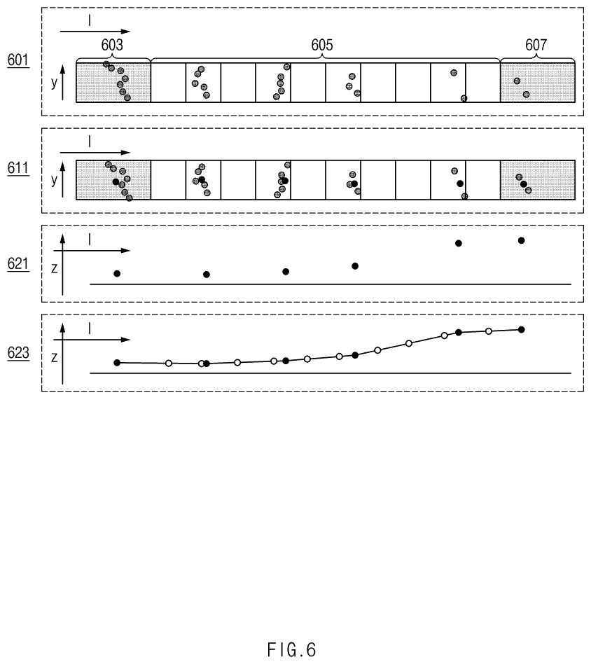

FIG. 6 shows an example of a representative point identified from classified points in an object recognition apparatus or an object recognition method according to an embodiment of the present disclosure.

Referring to FIG. 6, a first grid map 601 may include path points classified according to a distance between the host vehicle and the ground corresponding to the path points. The first grid map 601 may include a first preliminary grid 603, at least one grid 605, and a second preliminary grid 607. A second grid map 611 may include the same path points as the first grid map 601. The second grid map 611 may include representative points respectively corresponding to grids identified from the first grid map 601. A first graph 621 may display representative points identified from the second grid map 611 according to elevation. A second graph 623 may include interpolation points generated by performing interpolation between the representative points displayed in the first graph 621. The interpolation points may represent ground elevation information for the path along which the host vehicle is expected to travel.

According to an embodiment, the processor of the object recognition apparatus may generate a grid map identified according to the path along which the host vehicle is expected to travel. The processor of the object recognition apparatus may map, to a grid map, path points, which are points representing the ground and included in the path along which the host vehicle is expected to travel.

The first preliminary grid 603 and the second preliminary grid 607 may be reserved to perform interpolation. Due to the characteristics of sensor (e.g., LIDAR), a grid included in at least one grid 605 may not include a path point. In this case, the processor of the object recognition apparatus may secure a preliminary grid to perform interpolation. The size of the first preliminary grid 603 and the size of the second preliminary grid 607 may be set to a size that allows path points included in at least one layer to be detected.

According to an embodiment, the horizontal axis (e.g., l) of the first grid map 601, the horizontal axis (e.g., l) of the second grid map 611, and the horizontal axis (e.g., l) of the first graph 621, and the horizontal axis (e.g., l) of the second graph 623 may represent a distance between the host vehicle and the ground corresponding to the grid. The vertical axis (e.g., y) of the first grid map 601 and the vertical axis (e.g., y) of the second grid map 611 may represent a distance between the host vehicle and a representative point or an interpolation point. The vertical axis of the first graph 621 and the vertical axis of the second graph 623 may represent the elevation of the ground corresponding to the representative point or the interpolation point.

According to an embodiment, in the first grid map 601, the horizontal length of at least one grid 605 may refer to the length of a path along which the host vehicle is expected to travel. The path along which the host vehicle is expected to travel may have a specified length.

According to an embodiment, in the second grid map 611, the processor of the object recognition apparatus may identify one representative point (e.g., a solid dot) for each group corresponding to each grid according to the positions of classified points, based on the number of classified points included in each group being greater than a threshold number. The reason for this is that the points may be caused due to noise if the number of classified points included in the grid is less than or equal to the threshold number.

The longitudinal position of a representative point corresponding to each group may be identified based on the average value of the longitudinal positions of the classified points included in each group. The lateral position of the representative point corresponding to each group may be identified based on the average value of the lateral positions of the classified points included in each group. The elevation of the representative point may be identified based on the average value of the elevations of the classified points classified into each group.

According to an embodiment, in the first graph 621, the processor of the object recognition apparatus may display the elevation of a point according to a distance from the ground corresponding to the representative point to the host vehicle. Referring to the first graph 621, it may be identified that the elevation of the ground increases as the distance from the host vehicle increases.

In the second graph 623, the processor of the object recognition apparatus may estimate elevation information on the ground that does not correspond to the representative points by performing interpolation between the representative points for each group. The interpolation may be performed because a classified point may not exist in the grid as points may be lost due to the characteristics of sensor (e.g., LIDAR), and the lateral resolution may be lower than the longitudinal resolution.

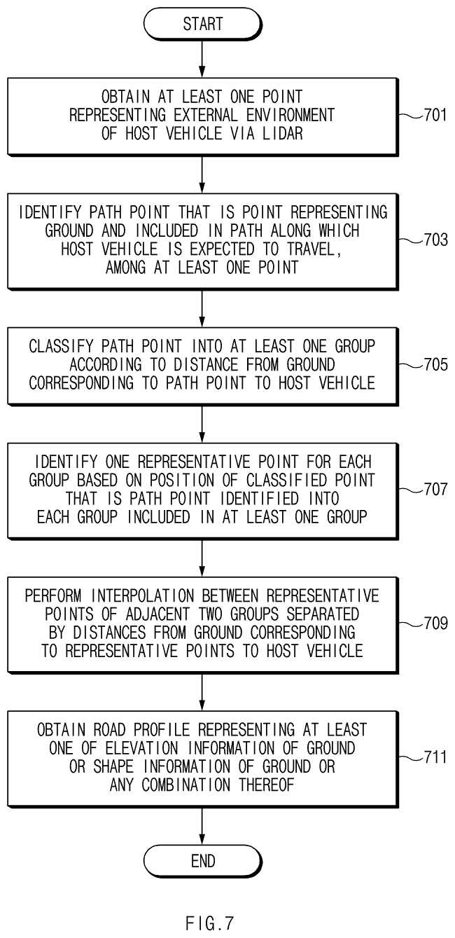

FIG. 7 illustrates a flowchart of operation of an object recognition apparatus for obtaining a road profile in an object recognition apparatus or an object recognition method according to an embodiment of the present disclosure.

Hereinafter, it is assumed that the processor 105 of the object recognition apparatus 101 of FIG. 1 performs the process of FIG. 7. Also, in the description of FIG. 7, the operations described as being performed by the processor of the object recognition apparatus may be understood as being controlled by the processor 105 of the object recognition apparatus 101.

Referring to FIG. 7, in a first operation 701, the processor of the object recognition apparatus according to an embodiment may obtain at least one point representing an external environment of the host vehicle through a sensor (e.g., LIDAR).

In a second operation 703, the processor of the object recognition apparatus according to an embodiment may identify a path point, which is a point representing the ground and included in a path along which the host vehicle is expected to travel, from among the at least one point.

In a third operation 705, the processor of the object recognition apparatus according to an embodiment may classify the path point into at least one group according to a distance between the host vehicle and the ground corresponding to the path point.

In a fourth operation 707, the processor of the object recognition apparatus according to an embodiment may identify one representative point for each group based on the location of a classified point, which is a path point classified into each of groups included in at least one group.

In a fifth operation 709, the processor of the object recognition apparatus according to an embodiment may perform interpolation between representative points corresponding to two adjacent groups separated according to a distance between the host vehicle and the ground corresponding to each of the representative points.

In a sixth operation 711, the processor of the object recognition apparatus according to an embodiment may obtain at least one of a road profile representing at least one of elevation information of the ground, or contour (e.g., shape) information of the ground, or any combination thereof. The elevation information of the ground may represent ground elevation information for a path along which the host vehicle is expected to travel. The contour (e.g., shape) information of the ground may represent ground contour (e.g., shape) information for the path along which the host vehicle is expected to travel.

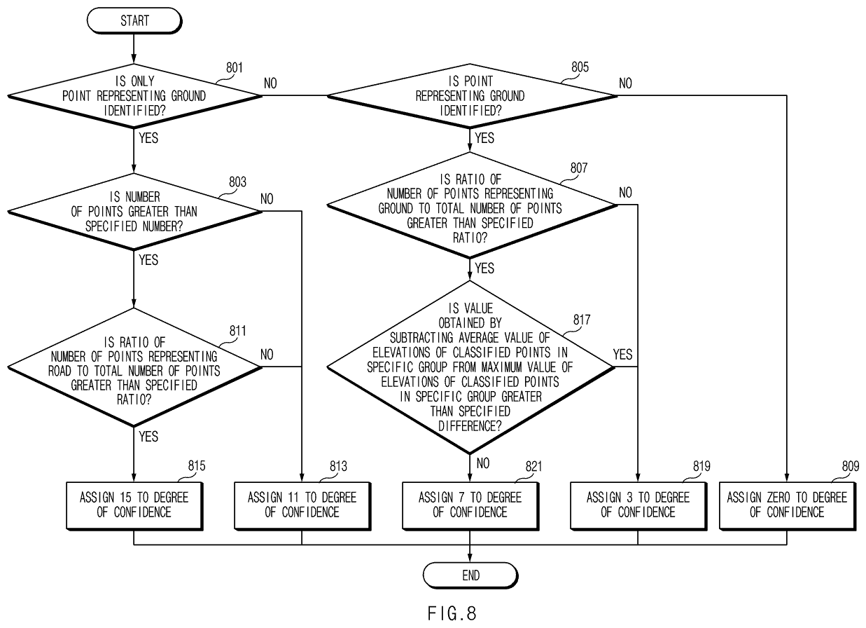

FIG. 8 illustrates a flowchart of operation of an object recognition apparatus for assigning a degree of confidence to a representative point in an object recognition apparatus or an object recognition method according to an embodiment of the present disclosure.

Hereinafter, it is assumed that the processor 105 of the object recognition apparatus 101 of FIG. 1 performs the process of FIG. 8. Also, in the description of FIG. 8, the operations described as being performed by the processor of the object recognition apparatus may be understood as being controlled by the processor 105 of the object recognition apparatus 101.

Referring to FIG. 8, the processor of the object recognition apparatus according to an embodiment may identify a degree of confidence of a representative point corresponding to each group based on at least one of the type of an object corresponding to classified points included in each group, the number of classified points included in each group, or the elevation of classified points included in each group, or any combination thereof.

The processor of the object recognition apparatus according to an embodiment may obtain a road profile based on the classified points obtained via the sensor (e.g., LIDAR), and assign a degree of confidence to the classified points included in each group based on the road profile. The processor of the object recognition apparatus according to an embodiment may assign a degree of confidence to a classified point if the degree of confidence is classified into a specified number of levels (e.g., five levels). For example, a degree of confidence in the absence of a road surface defect or obstacle may be greater than a degree of confidence in the presence of a road surface defect or obstacle on the ground. For example, a degree of confidence (e.g., about 15 points) when the distribution of elevation of the classified points in the group is uniform and the classified points in the group all represent the ground may be greater than a degree of confidence (e.g., about 0 points) when the distribution of elevation of the classified points in the group is not uniform and classified points representing a stationary object (e.g., a building) are included in the group.

In a first operation 801, the processor of the object recognition apparatus according to an embodiment may determine whether only points representing ground are identified. If only points representing the ground are identified, the processor of the object recognition apparatus may perform a second operation 803. If only points representing the ground are not identified, the processor of the object recognition apparatus may perform a third operation 805.

According to an embodiment, the points representing the ground may include points representing a roadway, points representing a sidewalk, points representing a parking lot, and points corresponding to a portion of the ground.

In a third operation 805, the processor of the object recognition apparatus may determine whether the points representing the ground are identified. If the points representing the ground are identified, the processor of the object recognition apparatus may perform a fourth operation 807. If the points representing the ground are not identified, the processor of the object recognition apparatus may perform a fifth operation 809.

According to an embodiment, the degree of confidence (e.g., a confidence score) of a representative point corresponding to a specific group when the number of classified points included in the specific group is greater than a specified number may be identified as being greater than the degree of confidence of a representative point corresponding to the specific group when the number of classified points included in the specific group is less than or equal to the specified number. In other words, the higher the degree of confidence may be the more (e.g., higher quantity) the classified points are included in the group.

In the fifth operation 809, the processor of the object recognition apparatus according to an embodiment may assign a degree of confidence of zero.

In the fourth operation 807, the processor of the object recognition apparatus according to an embodiment may identify whether the ratio of the number of points representing the ground to the total number of points is greater than a specified ratio. If the ratio of the number of points representing the ground to the total number of points is greater than the specified ratio, the processor of the object recognition apparatus may perform a sixth operation 817. If the ratio of the number of points representing the ground to the total number of points is less than or equal to the specified ratio, the processor of the object recognition apparatus may perform a seventh operation 819.

According to an embodiment, the processor of the object recognition apparatus may identify that the degree of confidence of the representative point corresponding to the specific group when a value obtained by subtracting the average value of the elevation represented by the classified points included in the specific group from the maximum value of the elevation represented by the classified points included in the specific group is greater than a specified difference is less than the degree of confidence of the representative point corresponding to the specific group when a value obtained by subtracting the average value from the maximum value is less than or equal to the specified difference. In other words, the lower the degree of confidence of a representative point may be the more the difference between the maximum value of the elevation and the average value of the elevation.

In the seventh operation 819, the processor of the object recognition apparatus according to an embodiment may assign a degree of confidence of 3.

In the sixth operation 817, the processor of the object recognition apparatus according to an embodiment may identify whether a value obtained by subtracting the average value of the elevation of the classified points in the specific group from the maximum value of the elevation of the classified points in the specific group is greater than the specified difference. If the value obtained by subtracting the average value of the elevation of the classified points in the specific group from the maximum value of the elevation of the classified points in the specific group is less than or equal to the specified difference, the processor of the object recognition apparatus may perform an eighth operation 821. If the value obtained by subtracting the average value of the elevation of the classified points in the specific group from the maximum value of the elevation of the classified points in the specific group is greater than the specified difference, the processor of the object recognition apparatus may perform the seventh operation 819.

In the eighth operation 821, the processor of the object recognition apparatus according to an embodiment may assign a degree of confidence of 7.

In the second operation 803, the processor of the object recognition apparatus according to an embodiment may identify whether the number of points is greater than a specified number. If the number of points is greater than the specified number, the processor of the object recognition apparatus may perform a ninth operation 811. If the number of points is less than or equal to the specified number, the processor of the object recognition apparatus may perform a tenth operation 813.

In the tenth operation 813, the processor of the object recognition apparatus according to an embodiment may assign a degree of confidence of 11.

In the ninth operation 811, the processor of the object recognition apparatus according to an embodiment may identify whether a ratio of the number of points representing roads to the total number of points is greater than a specified ratio. If the ratio of the number of points representing roads to the total number of points is greater than the specified ratio, the processor of the object recognition apparatus may perform an eleventh operation 815. If the ratio of the number of points representing roads to the total number of points is less than or equal to the specified ratio, the processor of the object recognition apparatus may perform the tenth operation 813.

In the eleventh operation 815, the processor of the object recognition apparatus according to an embodiment may assign a degree of confidence of 15.

FIG. 9 illustrates graphs for deriving criteria for assigning a degree of confidence in an object recognition apparatus or an object recognition method, according to an embodiment of the present disclosure.

Referring to FIG. 9, a first graph 901 may display the number of groups based on a value obtained by subtracting an average value of elevation represented by classified points included in a group from the maximum value of the elevation represented by the classified points in the group. The classified points shown in the first graph 901 may be obtained in correspondence with a flat ground whose elevation is included within a specified range.

A second graph 911 may display the number of groups according to the number of classified points representing the ground included in the group. The classified points representing the second graph 911 may display points obtained in correspondence with a curved ground whose elevation is out of the specified range.

According to an embodiment, in the first graph 901, in the case of a group according to classified points included in correspondence with the flat ground whose elevation is included within the specified range, the number of groups having a value obtained by subtracting the average value of elevation in the group from the maximum value of the elevation in the group may rapidly decrease after a specified difference (e.g., about 0.05 meters).

Therefore, the processor of the object recognition apparatus may identify whether a classified point included in the group corresponds to the flat ground based on the value obtained by subtracting the average value of the elevation from the maximum value of the elevation in the group, and the specified difference. For example, reference may be made to the sixth operation 817 of FIG. 8.

In other words, the processor of the object recognition apparatus according to an embodiment may identify a degree of confidence (e.g., about 3) of a representative point corresponding to a specific group when the value, obtained by subtracting the average value of the elevation represented by classified points included in the specific group from the maximum value of the elevation represented by the classified points in the specific group, is greater than a specified difference (e.g., about 0.05 meters), as being less than a degree of confidence (e.g., about 7) of the representative point corresponding to the specific group when the value obtained by subtracting the average value from the maximum value is less than or equal to the specified difference.

According to an embodiment, in the second graph 911, the number of groups according to the number of classified points included in groups and representing the ground may rapidly decrease after a specified number (e.g., 8). The classified points representing the second graph 911 may be obtained in correspondence with a curved ground.

The processor of the object recognition apparatus may identify whether points included in a group correspond to a curved ground based on the number of classified points representing the ground and included in the group and the specified number. For example, reference may be made to the second operation 803 of FIG. 8.

In other words, a degree of confidence (e.g., about 15) of a representative point corresponding to the specific group when the number of classified points included in the specific group is greater than the specified number (e.g., about 8) may be identified as being greater than to a degree of confidence (e.g., about 11) of a representative point corresponding to the specific group when the number of classified points included in the specific group is less than or equal to the specified number.

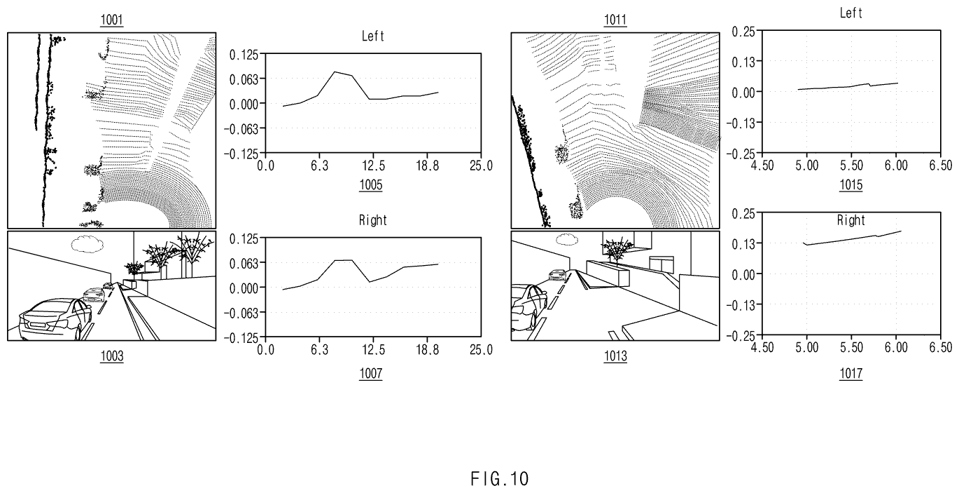

FIG. 10 illustrates an example of a road profile according to an embodiment of the present disclosure.

Referring to FIG. 10, a first screen 1001 may display a screen identified via a sensor (e.g., LIDAR) if a speed bump is included in a path along which a host vehicle is expected to travel. A first image 1003 may display a screen identified via a camera if a speed bump is included in the path along which the host vehicle is expected to travel. The path along which the host vehicle is expected to travel may include a first road profile 1005 for a predicted path of the left wheel, and a second road profile 1007 for a predicted path of the right wheel.

According to an embodiment, a processor of the object recognition apparatus may identify a portion corresponding to the speed bump based on the first road profile 1005, and the second road profile 1007.

A second screen 1011 may display a screen identified via a sensor (e.g., LIDAR) if a ramp is included in the path along which the host vehicle is expected to travel. A second image 1013 may display a screen identified via a camera if a ramp is included in the path along which the host vehicle is expected to travel. The path along which the host vehicle is expected to travel may include a third road profile 1015 for a predicted path of the left wheel, and a fourth road profile 1017 for a predicted path of the right wheel.

According to an embodiment, a processor of the object recognition apparatus may identify a portion corresponding to the ramp based on the third road profile 1015 and the fourth road file 1017.

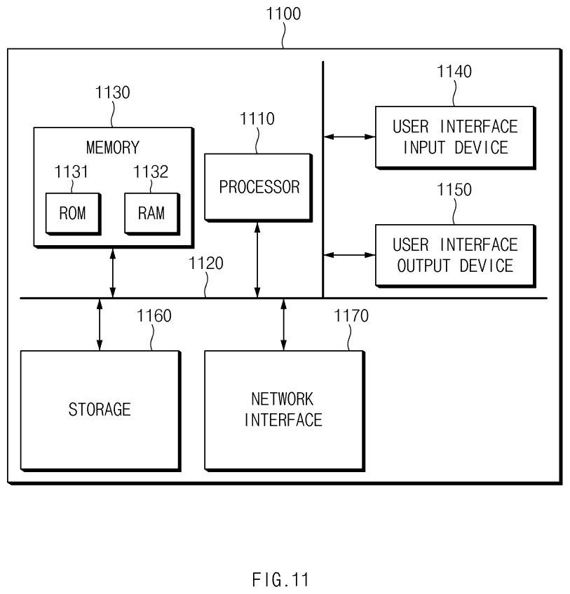

FIG. 11 illustrates a computing system related to an object recognition apparatus or an object recognition method according to an embodiment of the present disclosure.

Referring to FIG. 11, a computing system 1100 may include at least one processor 1110, a memory 1130, a user interface input device 1140, a user interface output device 1150, storage 1160, and a network interface 1170, which are connected with each other via a bus 1120.

The processor 1110 may be a central processing unit (CPU) or a semiconductor device that processes instructions stored in the memory 1130 and/or the storage 1160. The memory 1130 and the storage 1160 may include various types of volatile or non-volatile storage media. For example, the memory 1130 may include a ROM (Read Only Memory) 1131 and a RAM (Random Access Memory) 1132.

Thus, the operations of the method or the algorithm described in connection with the embodiments disclosed herein may be embodied directly in hardware or a software module executed by the processor 1110, or in a combination thereof. The software module may reside on a storage medium (that is, the memory 1130 and/or the storage 1160) such as a RAM, a flash memory, a ROM, an EPROM, an EEPROM, a register, a hard disk, a removable disk, and a CD-ROM.

The exemplary storage medium may be coupled to the processor 1110, and the processor 1110 may read information out of the storage medium and may record information in the storage medium. Alternatively, the storage medium may be integrated with the processor 1110. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may identify elevation information of the ground for a path along which a host vehicle is expected to travel, via a sensor (e.g., LIDAR).

Further, the present technology may improve accuracy of elevation information by identifying elevation information of the ground for a path along which a host vehicle is expected to travel, via a sensor (e.g., LIDAR).

Further, the present technology may improve driving stability by improving accuracy of elevation information of the ground for a path along which a host vehicle is expected to travel even though there is a road surface defect.

Further, the present technology may improve driver experience by improving the accuracy of elevation information of the ground for a path along which a host vehicle is expected to travel.

Further, the present technology may obtain elevation information of the ground which is robust to noise.

Further, the present technology may identify a degree of confidence of points corresponding to the ground.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a sensor; and
a processor configured to:
obtain, via the sensor, at least one point representing an external environment of a vehicle;
determine, among the at least one point, a plurality of path points representing positions on a ground, wherein the plurality of path points correspond to a path along which the vehicle is expected to travel;
classify each path point of the plurality of path points into at least one group of a plurality of groups, based on a distance between the vehicle and a position, on the ground, of each path point of the plurality of path points;
determine a representative point for each group of the plurality of groups, based on a position of each classified path point in a group, of the plurality of the groups, corresponding to the representative point;
determine, based on an interpolation between representative points of two adjacent groups of the plurality of groups, a road profile comprising at least one of elevation information of the ground or contour information of the ground; and
output, based on the determined road profile, a signal associated with autonomous driving control of the vehicle.

2. The apparatus of claim 1, wherein the processor is configured to determine the plurality of path points by:
determining a type of an object corresponding to each of the at least one point representing the external environment of the vehicle; and
determining the plurality of path points based on the type of the object and a position of the object.

3. The apparatus of claim 2, wherein the at least one point is included in input data of an artificial neural network (ANN), and wherein the processor is configured to determine the type of the object by:
determining the type of the object based on output data of the ANN.

4. The apparatus of claim 1, wherein the processor is further configured to determine a degree of confidence of the representative point for each group of the plurality of groups, based on at least one of: a type of an object corresponding to classified path points included in a group corresponding to the representative point, a quantity of the classified path points included in the group corresponding to the representative point, or an elevation of the classified path points included in the group corresponding to the representative point.

5. The apparatus of claim 1, wherein a first representative point corresponding to a first group, having greater than a specified quantity of classified path points, has a greater degree of confidence than a second representative point corresponding to a second group having less than the specified quantity of classified path points, and
wherein a third representative point corresponding to a third group has a greater degree of confidence than a fourth representative point corresponding to a fourth group, wherein a maximum elevation value of classified path points in the third group is not greater than an average elevation value of the classified path points included in the third group by at least a specified amount, and wherein a maximum value of classified path points in the fourth group is greater than an average elevation of the classified path points included in the fourth group by at least the specified amount.

6. The apparatus of claim 1, wherein the processor is configured to classify each point of the plurality of path points by:
classifying, into a first group, a first path point of the plurality of path points based on a first distance from a first position, on the ground, corresponding to the first path point to the vehicle satisfying a first distance range; and
classifying, into a second group, a second path point of the plurality of path points based on a second distance from a second position, on the ground, corresponding to the second path point to the vehicle satisfying a second distance range that is different from the first distance range.

7. The apparatus of claim 1, wherein the processor is further configured to:
determine, based on a steering angle of the vehicle, an expected trajectory of two front wheels with respect to a travel direction; and
determine the path based on the expected trajectory.

8. The apparatus of claim 1, wherein the processor is configured to determine the representative point for each group of the plurality of groups by:
determining the representative point based on at least one of:
an average longitudinal position of one or more path points, of the plurality of path points, that are classified into a group corresponding to the representative point; and
an average lateral position of the one or more path points that are classified into the group corresponding to the representative point, or
an average elevation of the one or more path points that are classified into the group corresponding to the representative point.

9. The apparatus of claim 1, wherein the path has a specified length.

10. The apparatus of claim 1, wherein the processor is configured to determine the representative point for each group of the plurality of groups by determining the representative point based on a quantity of classified path points included in the group corresponding to the representative point being greater than a threshold quantity.

11. A method comprising:
obtaining, via a sensor, at least one point representing an external environment of a vehicle;
determining, among the at least one point, a plurality of path points representing positions on a ground, wherein the plurality of path points correspond to a path along which the vehicle is expected to travel;
classifying each path point of the plurality of path points into at least one group of a plurality of groups, based on a distance between the vehicle and a position, on the ground, of each path point of the plurality of path points;
determining a representative point for each group of the plurality of groups, based on a position of each classified path point in a group, of the plurality of the groups, corresponding to the representative point;
determining, based on an interpolation between representative points of two adjacent groups of the plurality of groups, a road profile comprising at least one of elevation information of the ground or contour information of the ground; and
outputting, based on the determined road profile, a signal associated with autonomous driving control of the vehicle.

12. The method of claim 11, wherein the determining of the plurality of path points comprise:
determining a type of an object corresponding to each of the at least one point representing the external environment of the vehicle; and
determining the plurality of path points based on the type of the object and a position of the object.

13. The method of claim 12, wherein the at least one point is included in input data of an artificial neural network (ANN), and wherein the determining of the type of the object comprises:
determining the type of the object based on output data of the ANN.

14. The method of claim 11, further comprising:
determining a degree of confidence of the representative point for each group of the plurality of groups, based on at least one of: a type of an object corresponding to classified path points included in a group corresponding to the representative point, a quantity of the classified path points included in the group corresponding to the representative point, or an elevation of the classified path points included in the group corresponding to the representative point.

15. The method of claim 11, wherein a first representative point corresponding to a first group, having greater than a specified quantity of classified path points, has a greater degree of confidence than a second representative point corresponding to a second group having less than the specified quantity of classified path points, and
wherein a third representative point corresponding to a third group has a greater degree of confidence than a fourth representative point corresponding to a fourth group, wherein a maximum elevation value of classified path points in the third group is not greater than an average elevation value of the classified path points included in the third group by at least a specified amount, and wherein a maximum value of classified path points in the fourth group is greater than an average elevation of the classified path points included in the fourth group by at least the specified amount.

16. The method of claim 11, wherein the classifying of each point of the plurality of path points comprises:
classifying, into a first group, a first path point of the plurality of path points based on a first distance from a first position, on the ground, corresponding to the first path point to the vehicle satisfying a first distance range; and
classifying, into a second group, a second path point of the plurality of path points based on a second distance from a second position, on the ground, corresponding to the second path point to the vehicle satisfying a second distance range that is different from the first distance range.

17. The method of claim 11, further comprising:
determining, based on a steering angle of the vehicle, an expected trajectory of two front wheels with respect to a travel direction; and
determining the path based on the expected trajectory.

18. The method of claim 11, wherein the determining of the representative point for each group of the plurality of groups comprises:
determining the representative point based on at least one of:
an average longitudinal position of one or more path points, of the plurality of path points, that are classified into a group corresponding to the representative point; and
an average lateral position of the one or more path points that are classified into the group corresponding to the representative point, or
an average elevation of the one or more path points that are classified into the group corresponding to the representative point.

19. The method of claim 11, wherein the path has a specified length.

20. The method of claim 11, wherein the determining of the representative point for each group of the plurality of groups comprises:
determining the representative point based on a quantity of classified path points included in the group corresponding to the representative point being greater than a threshold quantity.
